(19) United States
(12) Patent Application Publication
(10) Pub. No.: US 2012/0000587 A1
(43) Pub. Date: Jan. 5, 2012

(54) Expandable Single and Dual Bead Locking Device

(75) Inventor: Larry K. Rogers, Bordentown, NJ (US)

(73) Assignee: Rogers

(21) Appl. No.: 12/830,403

(22) Filed: Jul. 5, 2010

(51) Int. Cl. B60C 15/02

(52) U.S. Cl. 152/385

(57) ABSTRACT

This improved bead locking apparatus and system is based on the provision of an expandable single and/or dual bead lock device with a bead compression ring that thrusts against the bead(s) of tire from the inside and is braced against and via the drop center of the wheel rim and/or an opposing bead compression ring. The aforesaid ring or rings are caused to press against the tire bead(s) via mechanical means actuated by a screw driver or similar implement. In single bead lock designs, the said implement can be inserted between the bead and rim on the side of the wheel opposite from that where the compression ring is located. In other designs, the said implement is inserted through an opening in the rim (which is preferably located in the drop center area of the rim) that is sealed with an O-ring, valve or plug. The bead lock designs of the invention may also be advantageously combined with a run flat ring in order to further facilitate the objects of the invention in assisting and enabling run flat capabilities.

### BACKGROUND AND SUMMARY

This invention pertains generally to bead locking devices. More particularly, it deals with dual and/or single bead locking devices for use alone or in combination with an optional run flat ring.

Bead locking devices were developed to ensure that, when a tire is run at a low level of pressure or zero pressure, the tire will not run off of the wheel or spin freely on the wheel, rendering the vehicle immobile. Both external and internal bead locking devices are currently used for this purpose. An external bead lock consists of a ring mounted outside of the tire and rim flange, which is attached to the rim flange with hardware. (See, e.g., FIG. 8 and U.S. Pat. No. 4,505,314). The hardware compresses the tire bead between the rim flange and the ring. An internal bead lock mounted on a multi-piece wheel, consists of a cylindrical ring wrapped around the circumference of the wheel, which compress both tire beads into the internal bead lock, locking the assembly together, when the two halves of the wheel are compressed together via the assembly hardware. (See. e.g., FIG. 9 and U.S. Pat. No. 5,271,443). An alternative embodiment of the internal bead lock is a combined bead lock and run flat as shown in FIG. 10, mounted on a multi-piece wheel. (See. e.g., U.S. Pat. No. 6,076,578). This system follows the same premise as the others outlined above, but with the addition of run flat functionality.

However, both types of prior art bead locking devices have disadvantages. First, external bead locks are not Department of Transportation (DOT) approved, and are solely intended for “Off the Road” applications. In addition, external bead locks have a high probability of damaging the tire, shortening the life of the tire itself, and can increase the overall width of the vehicle. Second, multi-piece wheels require additional hardware to assemble, adding weight and cost to the assembly, and also creating a potential risk for failure of the wheel/tire assembly (air leakage or broken assembly bolts). Third, both of the previous methods require the user to replace their current wheel to utilize a bead lock function. Thus, there is a substantial need for improved bead locking capabilities and systems and especially for improved bead locking capabilities that can be used with one-piece wheels.

The purpose of this invention is to retain or lock one or both of the tire beads to the rim flange(s) on a one-piece wheel and tire assembly (though it could also be used with a multi-piece wheel assembly). In addition, the invention will optionally provide run flat capabilities to the wheel/tire assembly. This is accomplished via the provision of an expandable single and/or dual bead lock device that avoids the problems inherent in external bead locks of the type illustrated in FIG. 8 and taught in U.S. Pat. No. 4,505,314. It does this by providing a bead locking device with a bead compression ring that is thrust against the bead(s) of the tire from the inside and is braced against and via the drop center of the wheel rim and/or an opposing bead compression ring. The aforesaid ring or rings are caused to press against the tire bead(s) via mechanical means actuated by a screw driver or similar implement. In single bead lock designs, the said implement can be inserted between the bead and rim on the side of the wheel opposite from that where the compression ring is located. In other designs, the said implement is inserted through an opening in the rim (which is preferably located in the drop center area of the rim) that is sealed with an O-ring, valve or plug. The bead lock designs of the invention may also be advantageously combined with a run flat ring in order to further facilitate the objects of the invention in assisting and enabling run flat capabilities.

The foregoing features and others of the inventive concept, as more fully described below, provide numerous advantages over the systems of prior art. First, the invention allows an internal bead lock to be installed on a one-piece wheel. Second, the invention allows the wheel drop center to still be fully utilized to allow for easy installation of the tire on the wheel. Third, the invention allows either one or both beads to be locked to the rim. Fourth, since a one-piece wheel is used, the overall amount of hardware used in the assembly is reduced, reducing assembly weight. Fifth, assembly time is reduced since less hardware must be installed. Sixth, elimination of wheel assembly hardware eliminates potential wheel failure points. Seventh, elimination of wheel assembly hardware reduces the cost of the wheel assembly. Eighth, the expandable bead lock device taught herein is DOT compliant. Ninth, the expandable bead lock device taught herein does not damage the tire, and is reusable. Tenth, the expandable bead lock device of the invention can be installed with standard tools. The numerous other advantages of our invention will become more apparent in view of the more detailed description and claims that follow.

### BRIEF DESCRIPTION OF THE DRAWINGS

FIG. 1 provides a schematic perspective partial cross-sectional view of an expandable single bead locking device in accordance with the teachings of the invention positioned on a wheel rim with a tightening implement inserted for use in actuating the compression ring of the device.

FIG. 2 provides a schematic perspective partial cross-sectional view of the expandable single bead locking device of FIG. 1 further including a run flat ring.

FIG. 3 provides a schematic perspective partial cross-sectional view of an expandable dual bead locking device including run flat ring and dual compression rings in accordance with the teachings of the invention positioned on a wheel rim prior to actuation of the compression rings of the device.

FIG. 4 provides a schematic perspective partial cross-sectional view of the expandable dual bead locking device of FIG. 3 after actuation of the compression rings of the device.

FIG. 5 provides a schematic perspective partial cross-sectional view of an expandable dual bead locking device including run flat ring and dual compression rings (with an alternative mechanism for expanding the compression rings of the device) positioned on a wheel rim in accordance with the teachings of the invention prior to actuation of the compression rings of the device.

FIG. 6 provides a schematic perspective partial cross-sectional view of the expandable dual bead locking device of FIG. 5 after actuation of the compression rings of the device.

FIG. 7 provides another schematic perspective partial cross-sectional view of the expandable dual bead locking device of FIGS. 5 and 6, providing further detail with regard to the actuation mechanisms thereof.

FIG. 8 provides schematic cross-sectional views of a prior art external bead locking device in accordance with the teachings of U.S. Pat. No. 4,505,314 positioned on a wheel rim.

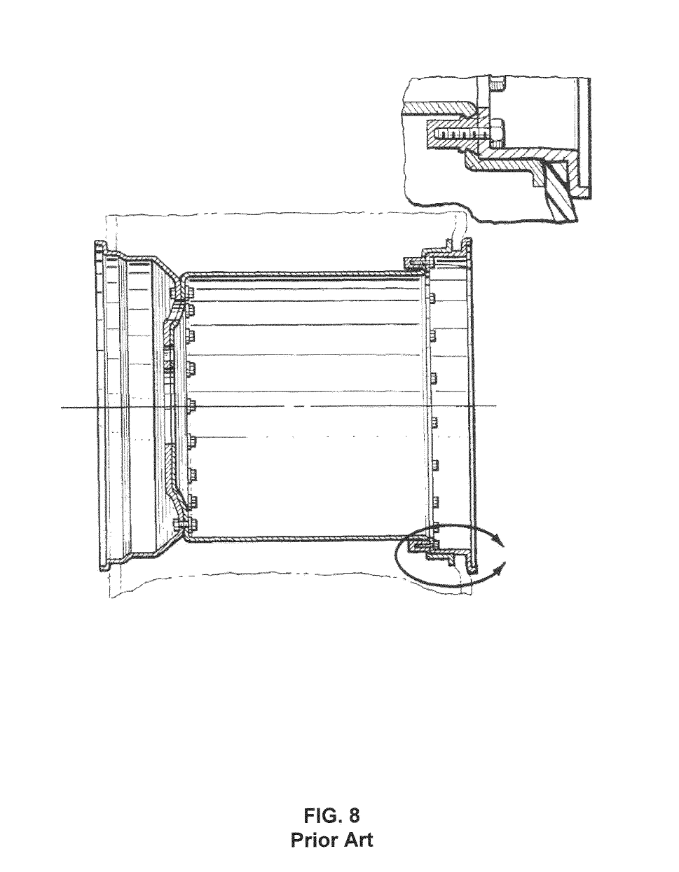

FIG. 9 provides a schematic cross-sectional view of a prior art internal bead locking device in accordance with the teachings of U.S. Pat. No. 5,271,443 positioned on a wheel rim.

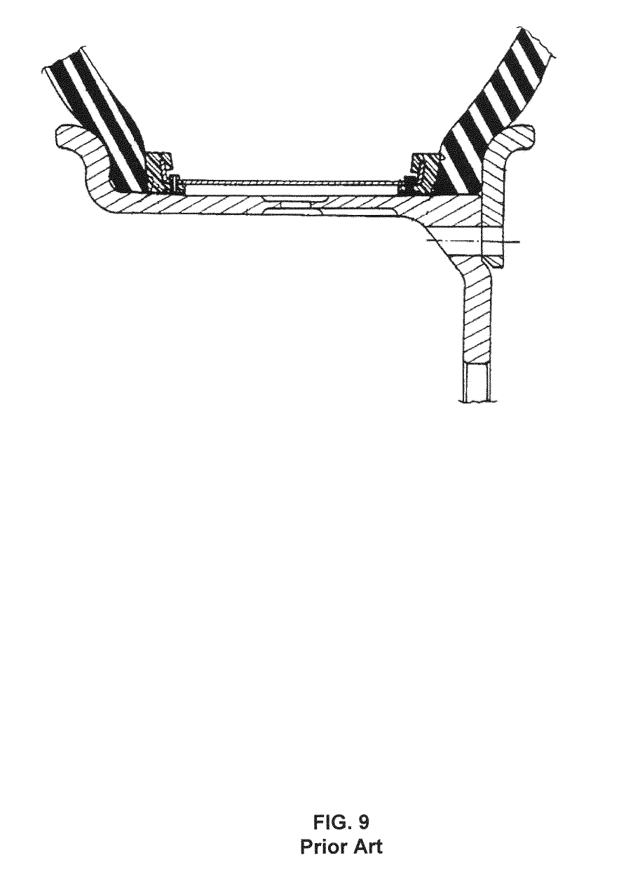

FIG. 10 provides schematic cross-sectional views of a prior art combination run flat and internal bead locking device in accordance with the teachings of U.S. Pat. No. 6,076,578 positioned on a wheel rim.

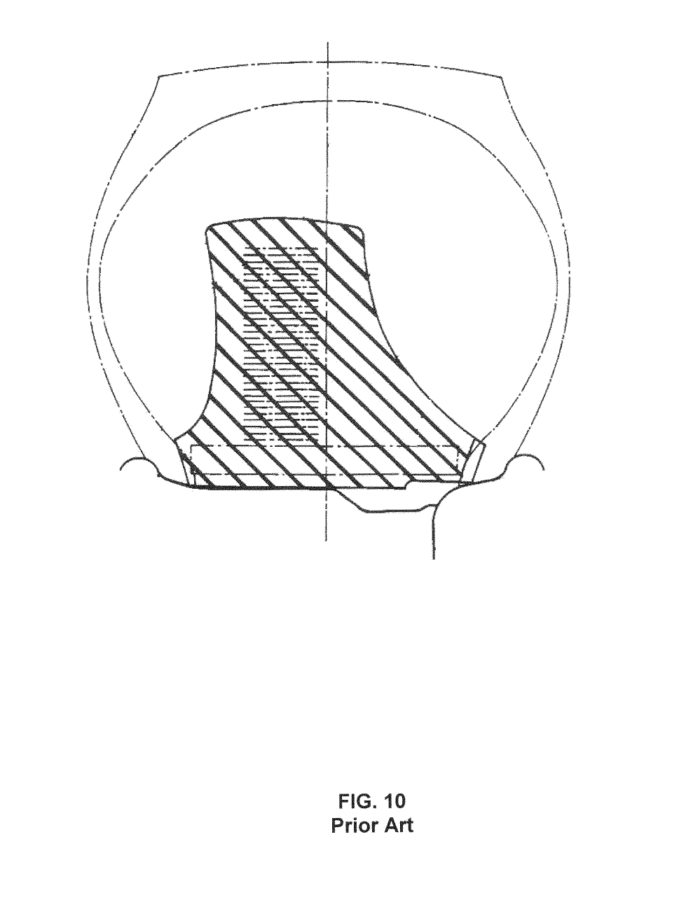

FIG. 11 provides a schematic cross-sectional view of a prior art threaded connection for use in locking a run flat ring into position on a wheel rim in accordance with the teachings of U.S. Pat. No. 5,626,696.

FIG. 12 provides a schematic side view of an interface between worm drive gear, threaded shaft, and flexible cable in the embodiments illustrated in FIGS. 3 and 4, providing further detail with regard thereto.

FIG. 13 provides a schematic cross-sectional view of an access hole sealed by a plug of a type that can be used for accessing and manipulating, e.g., worm drive gear(s) and thereby actuating the compression rings of the invention.

### DESCRIPTION

A multi-piece wheel is comprised of two or more sections which are assembled together. Typically, two halves encapsulate the tire and bead lock device during the assembly process, allowing the user to install the tire without manipulating the tire beads around the rim flanges. A single piece wheel contains only one section, requiring the user to install the tire by stretching the beads over the rim flanges, using the drop center to allow adequate bead stretching.

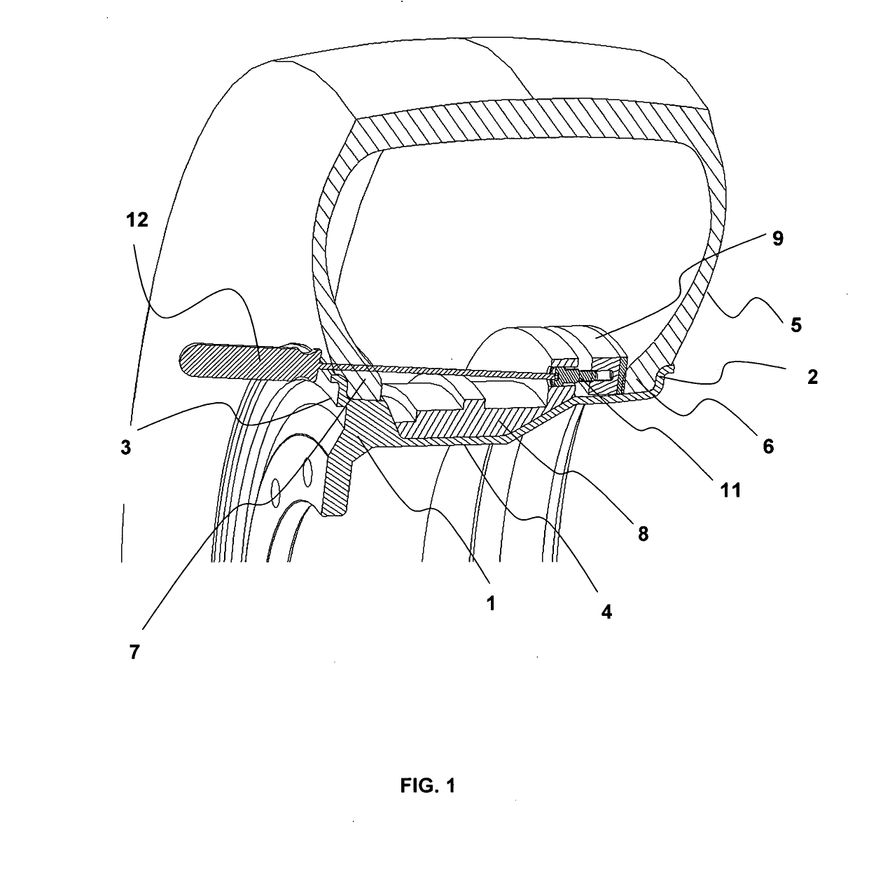

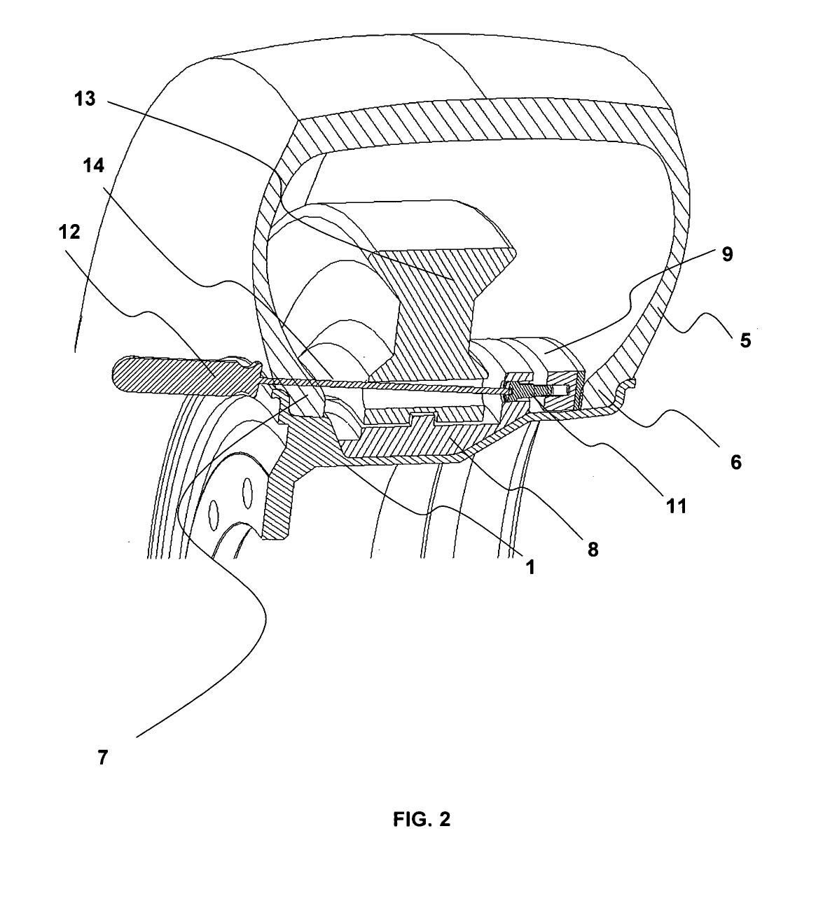

FIGS. 1 and 2 show a single bead locking version of the expandable bead lock device of the invention in position on a single piece wheel (1). To place the invention, the inner tire bead (6) is first installed onto the wheel (1). Then the expandable single bead lock insert (8) is fitted around the wheel (1). The outer tire bead (7) is then installed onto the wheel (1). By sliding a screwdriver (12) under the outer tire bead (7) (tire bead 7 is shown in-place in the figure); the assembly shoulder screws (11) can be turned, pushing the bead compression ring (9) outwards into the inner tire bead (6), locking it to the rim flange (2). Multiple assembly shoulder screws (11) would be located around the circumference of the wheel (1) to allow an even distribution of bead lock force.

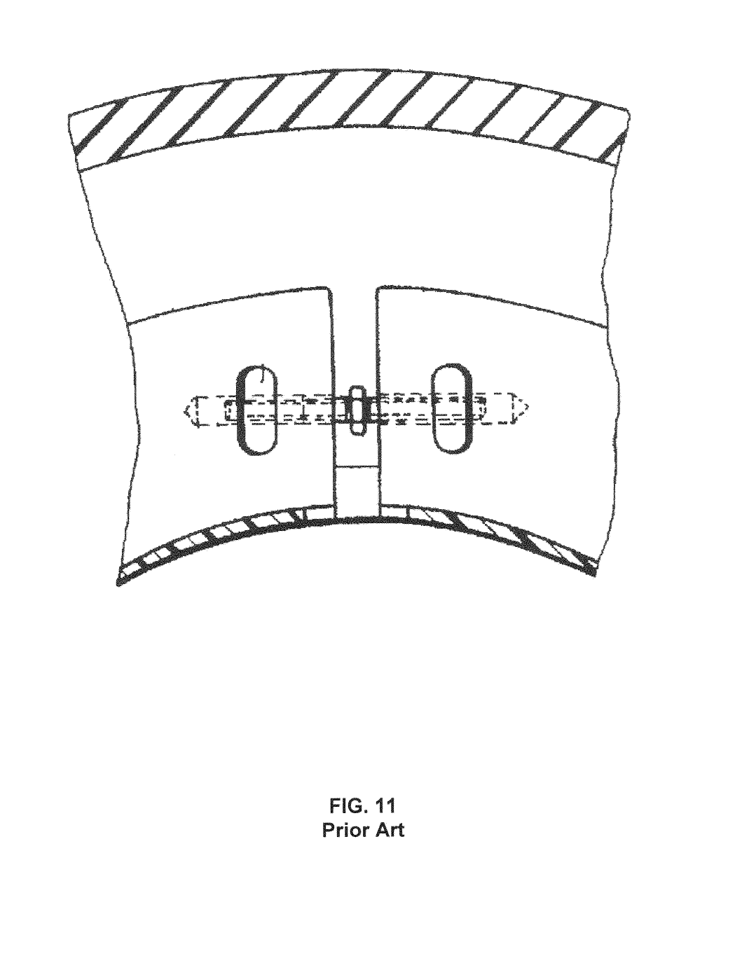

FIG. 2 shows the addition of an optional run flat ring (13) to the embodiment illustrated in FIG. 1. As in the prior embodiment, the inner tire bead (6) is initially installed onto the wheel (1). Then the expandable single bead lock insert (8) is fitted around the wheel (1). The run flat ring (13) is fitted onto the expandable single bead lock insert (8) after the insert is fitted around the wheel (1). The run flat ring (13) may be locked around the expandable single bead lock insert (8) via a threaded connection (see, e.g., FIG. 11 and Patent No. 5,626,696 as an example). The outer tire bead (7) is then installed onto the wheel (1). By sliding a screwdriver (12) under the outer tire bead (7) (tire bead 7 is shown in-place in the figure) and through the access hole (14) in the run flat ring (13), the assembly shoulder screws (11) can be turned, pushing the bead compression ring (9) outwards into the inner tire bead (6), locking it to the rim flange (2).

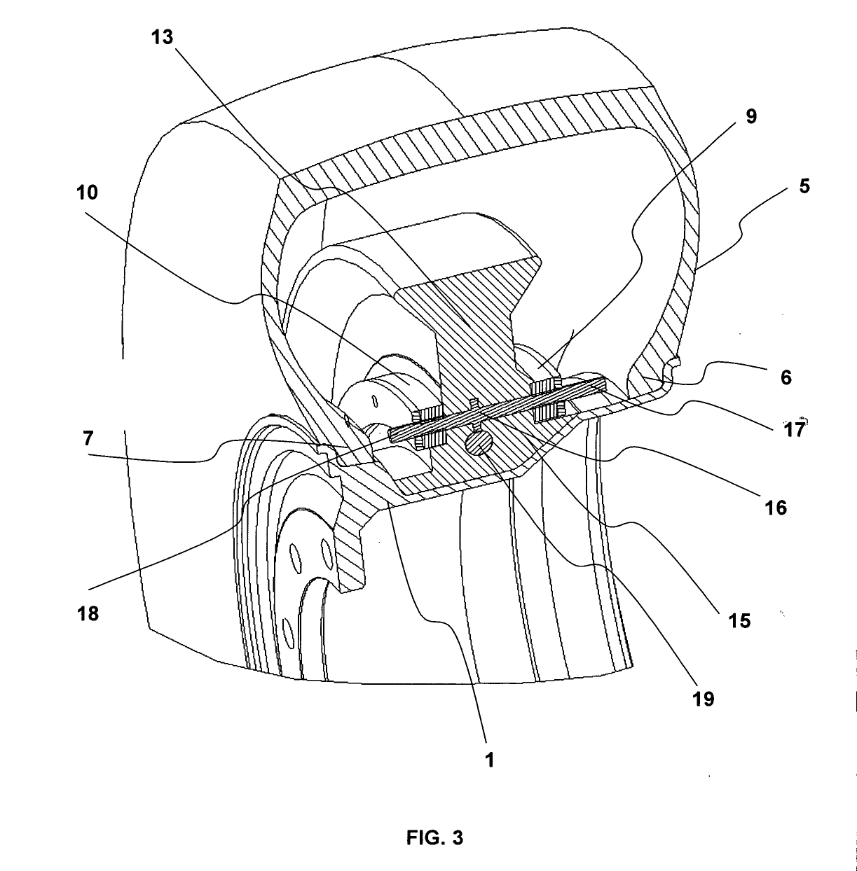

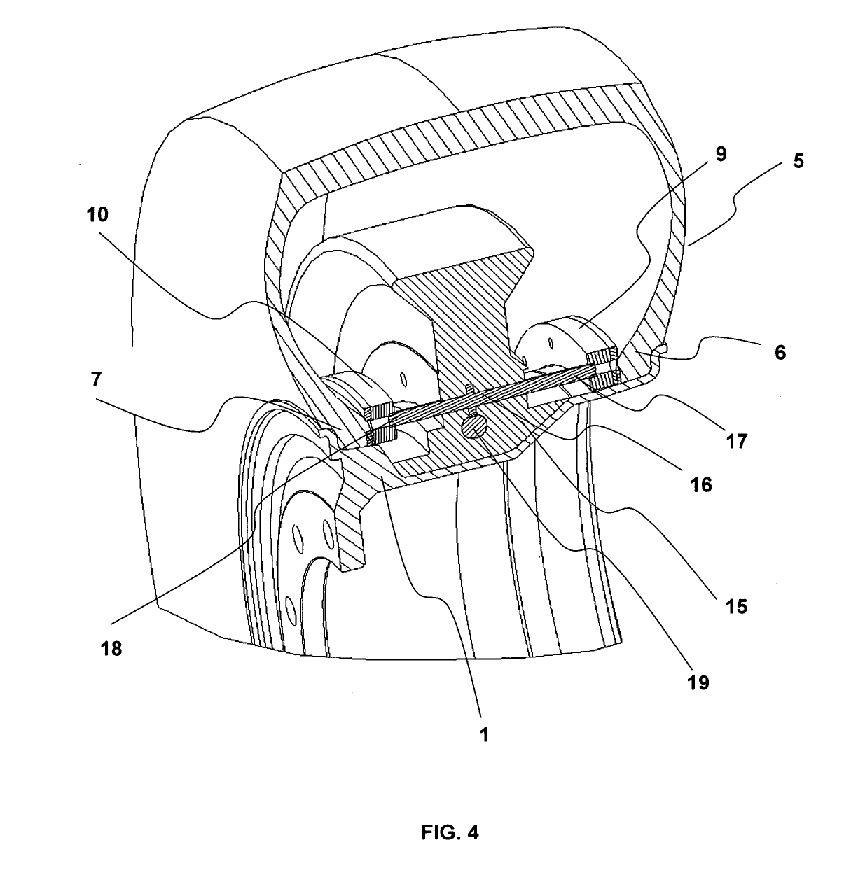

FIGS. 3 and 4 show an expandable dual bead locking embodiment of the invention, with an optional run flat ring (13) installed. As with the single bead lock version, the inner tire bead (6) is installed onto the wheel (1), and the expandable dual bead lock insert (15) is fitted around the wheel (1). Then, the outer tire bead (7) is installed onto the wheel (1). Once both tire beads (6, 7) are installed, the worm drive gear (19) is turned, (an electric motor or other device can be used to turn the worm gear). The rotation of the worm drive gear (19) causes the threaded shaft (16) to spin inside the expandable dual head lock insert (15). The opposing threads (17, 18) on the threaded shaft (19) push the two bead compression rings (9, 10) outwards to compress and lock the tire beads (6, 7). FIG. 3 shows the expandable dual bead lock device with bead compression rings (9, 10) retracted for assembly. FIG. 4 shows the expandable dual bead lock device with bead compression rings (9, 10) expanded into the tire heads (6, 7).

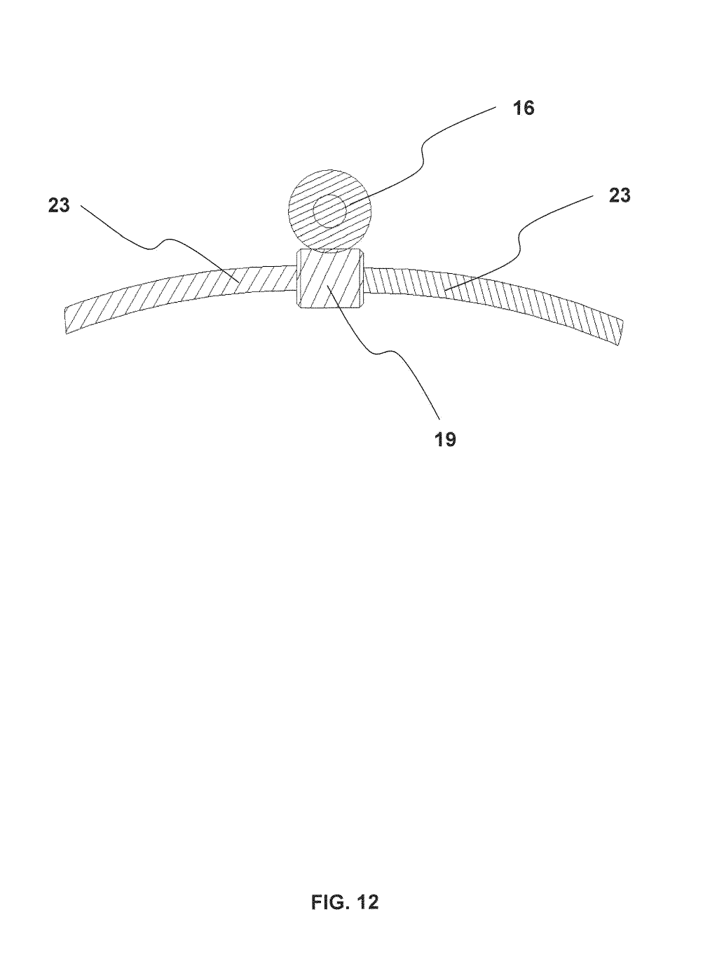

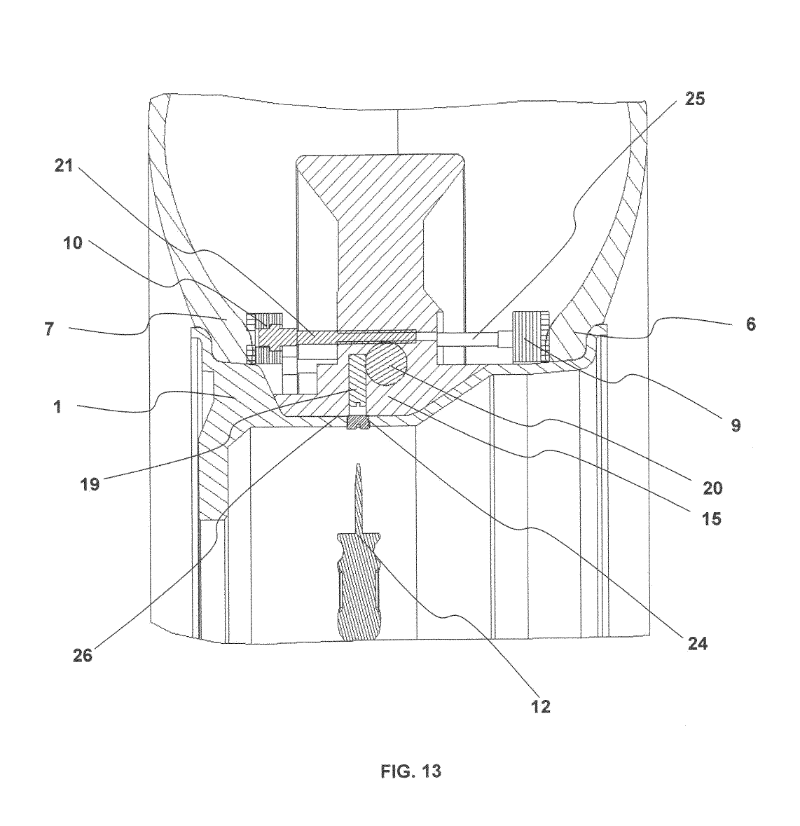

As with the single bead lock assembly, multiple threaded shafts (16) should be advantageously located around the circumference of the wheel (1) to evenly distribute the bead lock force. The worm drive gears (19) that accompany each threaded shaft (16) would be linked via a flexible cable (23), enabling the user input at one location via an access hole (24) in the wheel (1) to drive all of the worm drive gears (19). This configuration is shown in FIG. 12. An example access hole (24) is illustrated in FIG. 13, sealed against air leaks via a plug (26).

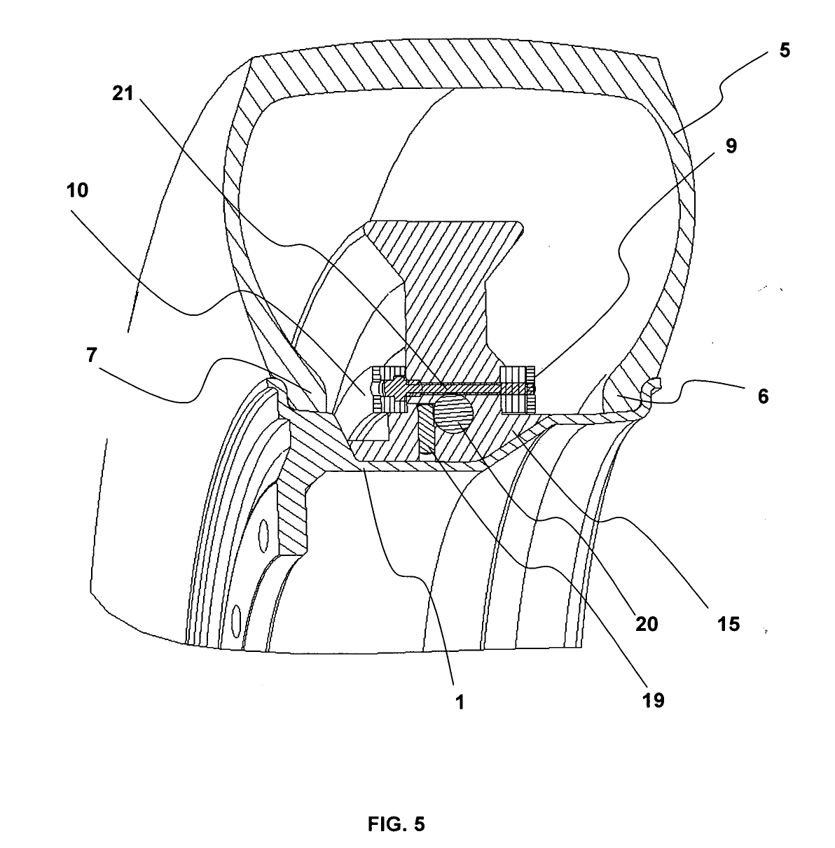

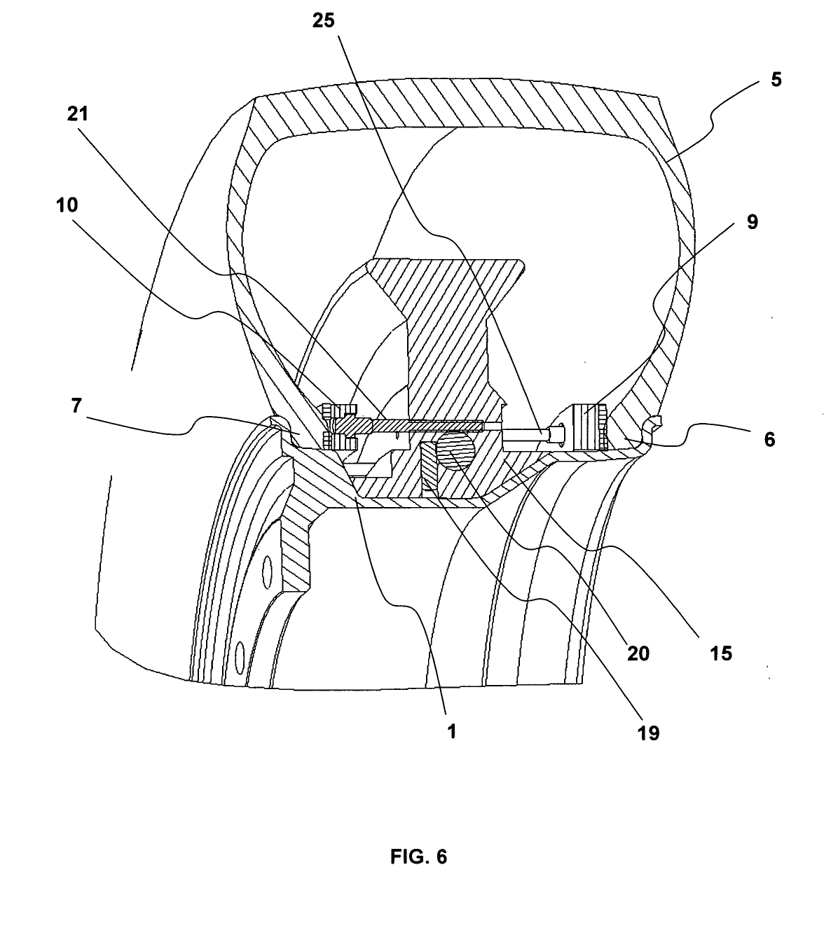

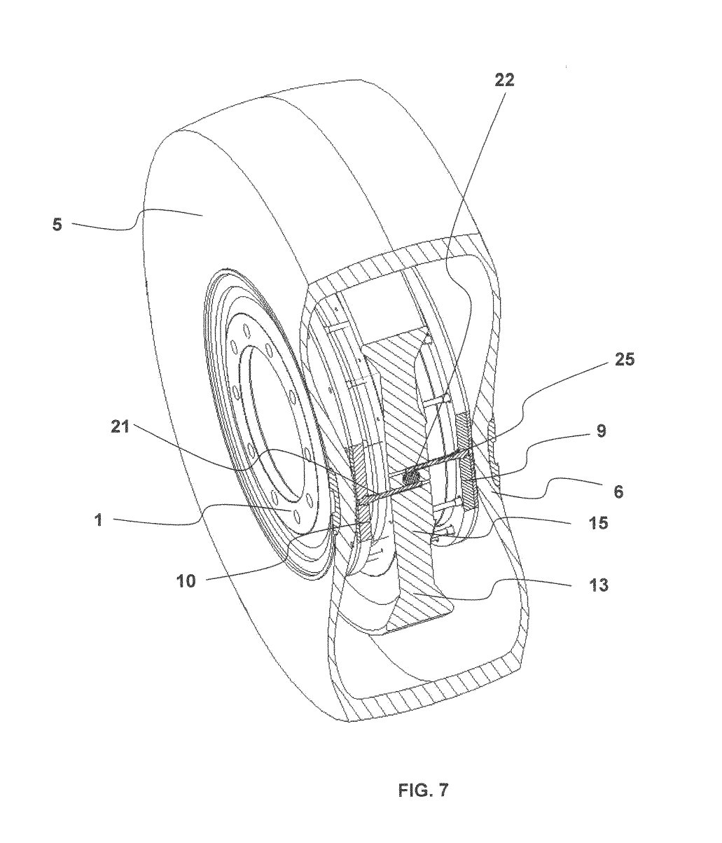

FIGS. 5, 6 and 7 show an alternative mechanism for expanding the bead compression rings (9, 10) outward into the tire beads (6, 7). FIG. 5 shows the bead compression rings (9, 10) retracted for assembly purposes, and FIG. 6 shows the bead compression rings (9, 10) expanded into the tire beads (6, 7), locking them to the rim flanges (2, 3). The installation procedure for this expandable dual bead lock device is the same as above. Once the expandable dual bead lock insert (15) is fitted to the wheel (1) and both tire beads (6, 7) have been installed, the user then turns the worm drive gear (19) from outside the wheel (1), through an access hole (24). The worm drive gear (19) causes the driven spur gear (20) to rotate, which imparts a linear rack-and-pinion motion on the threaded half-shafts (21, 25), which push the bead compression rings (9, 10) outward into the tire beads (6, 7). FIG. 7 shows that as one threaded half-shaft (21) moves outward, an intermediate spur gear (22) will rotate, imparting an opposite linear rack-and-pinion motion on the opposing threaded half-shaft (25), moving it outwards, and forcing the second bead compression ring (9) into the tire bead (6). As with the embodiments discussed above, the gearing mechanisms (19, 20, 21, 22, 25) may be advantageously located at several places around the circumference of the wheel to evenly distribute the bead locking force.

The previously described advantages and features of the invention are advantageously provided through and using the preferred embodiments previously illustrated and discussed. However, numerous variations are possible without deviating from and/or exceeding the spirit and scope of the invention. In addition, various features and functions disclosed above, or alternatives thereof, may be desirably combined into many other different systems or applications. Further, various presently unforeseen or unanticipated alternatives, modifications, variations or improvements therein may be subsequently made by those skilled in the art which are also intended to be encompassed by the claims to be filed.

Finally, the following parts list for the drawing figures may be found to be of assistance in understanding more fully the concepts of our invention:
1 Wheel
2 Rim Flange
3 Rim Flange
4 Drop Center
5 Tire
6 Inner Tire Bead
7 Outer Tire Bead
8 Expandable Single Bead Lock Insert
9 Bead Compression Ring
10 Bead Compression Ring
11 Assembly Shoulder Screw
12 Screwdriver
13 Run Flat Ring
14 Access Hole
15 Expandable Dual Bead Lock Insert
16 Threaded Shaft
17 Threads on Shaft
18 Threads on Shaft
19 Worm Drive Gear
20 Driven Spur Gear
21 Threaded Half-Shaft
22 Intermediate Spur Gear
23 Flexible Cable
24 Access Hole
25 Threaded Half-Shaft
26 Plug

What is claimed is:

1. An expandable bead lock device for use with a tubeless tire mounted on a wheel rim of a motor vehicle, the wheel rim having a drop center and annular flanges, and the tire including beads mounted against the flanges of said rim, comprising:
a bead compression ring arranged to compress a bead against a flange of said rim; and
wherein said bead compression ring at least one of: thrusts against and away from a bead lock insert mounted adjacent said rim intermediate said flanges to compress said bead against said flange, thrusts against and away from a bead lock insert braced by said drop center to compress said bead against said flange, and thrusts against and away from an other bead compression ring arranged to compress the other bead against the other flange of said rim.

2. An expandable bead lock device as described in claim 1, further comprising at least one of
a run flat ring intermediate said bead lock insert and said tubeless tire, and
a threaded member intermediate and connecting said bead compression ring and said bead lock insert, which threaded member can be turned to thrust said bead compression ring against and away from at least one of the bead lock insert and the other bead compression ring.

3. An expandable bead lock device as described in claim 2, wherein a screw driver can be inserted between said other bead and other flange and used to turn said threaded member so as to thrust said bead compression ring against and away from at least one of the bead lock insert and the other bead compression ring.

4. An expandable bead lock device as described in claim 2, further comprising an access hole in at least one of said expandable bead lock device and said rim whereby a screw driver can be inserted and used to cause the turning of said threaded member so as to thrust said bead compression ring against and away from at least one of the bead lock insert and the other bead compression ring.

5. An expandable bead lock device as described in claim 2, wherein at least one of:
said threaded member has threads on an end interacting with said bead compression ring such that the bead compression ring slides along said threaded member when the threaded member is turned,
said threaded member is a linear member having threads at opposite ends thereof, with the threads on an end interacting with said bead compression ring and threads on the other end interacting with said other bead compression ring such that the bead compression ring and the other bead compression ring slide along said threaded member when the threaded member is turned,
said threaded member slides relative to said bead lock insert when the threaded member is turned, and
said threaded member comprises two threaded half shafts which slide relative to said bead lock insert when turned.

6. An expandable bead lock device as described in claim 3, wherein at least one of:
said threaded member has threads on an end interacting with said bead compression ring such that the bead compression ring slides along said threaded member when the threaded member is turned,
said threaded member is a linear member having threads at opposite ends thereof, with the threads on an end interacting with said bead compression ring and threads on the other end interacting with said other bead compression ring such that the bead compression ring and the other bead compression ring slide along said threaded member when the threaded member is turned,
said threaded member slides relative to said bead lock insert when the threaded member is turned, and
said threaded member comprises two threaded half shafts which slide relative to said head lock insert when turned.

7. An expandable bead lock device as described in claim 4, wherein at least one of:
said threaded member has threads on an end interacting with said bead compression ring such that the bead compression ring slides along said threaded member when the threaded member is turned,
said threaded member is a linear member having threads at opposite ends thereof, with the threads on an end interacting with said bead compression ring and threads on the other end interacting with said other bead compression ring such that the bead compression ring and the other bead compression ring slide along said threaded member when the threaded member is turned,
said threaded member slides relative to said bead lock insert when the threaded member is turned, and
said threaded member comprises two threaded half shafts which slide relative to said bead lock insert when turned.

8. An expandable bead lock device as described in claim 5, further comprising at least one of at least one worm drive gear, where turning said at least one worm drive gear causes the turning of said threaded member,
at least one worm drive gear interacting with said threaded member via a driver spur gear, where turning said at least one worm drive gear causes the turning of said driver spur gear to turn said threaded member,
at least one intermediate spur gear intermediate said two threaded half shafts, whereby rotation of the at least one intermediate spur gear imparts a linear rack-and-pinion motion to said two threaded half shafts, and
at least one flexible cable, where turning said at least one cable causes the turning of said threaded member.

9. An expandable bead lock device as described in claim 6, further comprising at least one of
at least one worm drive gear, where turning said at least one worm drive gear causes the turning of said threaded member,
at least one worm drive gear interacting with said threaded member via a driver spur gear, where turning said at least one worm drive gear causes the turning of said driver spur gear to turn said threaded member.
at least one intermediate spur gear intermediate said two threaded half shafts, whereby rotation of the at least one intermediate spur gear imparts a linear rack-and-pinion motion to said two threaded half shafts, and
at least one flexible cable, where turning said at least one cable causes the turning of said threaded member.

10. An expandable bead lock device as described in claim 7, further comprising at least one of
at least one worm drive gear, where turning said at least one worm drive gear causes the turning of said threaded member,
at least one worm drive gear interacting with said threaded member via a driver spur gear, where turning said at least one worm drive gear causes the turning of said driver spur gear to turn said threaded member,
at least one intermediate spur gear intermediate said two threaded half shafts, whereby rotation of the at least one intermediate spur gear imparts a linear rack-and-pinion motion to said two threaded halt shafts, and
at least one flexible cable, where turning said at least one cable causes the turning of said threaded member.

11. An expandable head lock device as described in claim 2, wherein said at least one threaded member is a plurality of threaded members spaced around said bead lock insert, said plurality of threaded members being linked by a flexible cable such that said plurality of threaded members can be simultaneously turned.

12. An expandable bead lock device as described in claim 3, wherein said at least one threaded member is a plurality of threaded members spaced around said bead lock insert, said plurality of threaded members being linked by a flexible cable such that said plurality of threaded members can be simultaneously turned.

13. An expandable bead lock device as described in claim 4, wherein said at least one threaded member is a plurality of threaded members spaced around said bead lock insert, said plurality of threaded members being linked by a flexible cable such that said plurality of threaded members can be simultaneously turned.

14. An expandable bead lock device as described in claim 5, wherein said at least one threaded member is a plurality of threaded members spaced around said bead lock insert, said plurality of threaded members being linked by a flexible cable such that said plurality of threaded members can be simultaneously turned.

15. An expandable bead lock device as described in claim 6, wherein said at least one threaded member is a plurality of threaded members spaced around said bead lock insert, said plurality of threaded members being linked by a flexible cable such that said plurality of threaded members can be simultaneously turned.

16. An expandable head lock device as described in claim 7, wherein said at least one threaded member is a plurality of threaded members spaced around said bead lock insert, said plurality of threaded members being linked by a flexible cable such that said plurality of threaded members can be simultaneously turned.

17. An expandable bead lock device as described in claim 8, wherein said at least one threaded member is a plurality of threaded members spaced around said bead lock insert, said plurality of threaded members being linked by a flexible cable such that said plurality of threaded members can be simultaneously turned.

18. An expandable bead lock device as described in claim 9, wherein said at least one threaded member is a plurality of threaded members spaced around said bead lock insert, said plurality of threaded members being linked by a flexible cable such that said plurality of threaded members can be simultaneously turned.

19. An expandable bead lock device as described in claim 10, wherein said at least one threaded member is a plurality of threaded members spaced around said bead lock insert, said plurality of threaded members being linked by a flexible cable such that said plurality of threaded members can be simultaneously turned.
